(19) United States
(12) Patent Application Publication
(10) Pub. No.: US 2023/0241440 A1
(43) Pub. Date: Aug. 3, 2023

(54) SYSTEM AND METHOD OF INSPECTING FIRE EXTINGUISHERS

(71) Applicant: David Biglen, Hillsboro, OR (US)

(72) Inventor: David Biglen, Hillsboro, OR (US)

(21) Appl. No.: 18/159,008

(22) Filed: Jan. 24, 2023

Related U.S. Application Data
(60) Provisional application No. 63/303,987, filed on Jan. 28, 2022.

(51) Int. Cl. A62C 37/50; H04N 7/18; G06V 20/52

(52) U.S. Cl. CPC A62C 37/50; H04N 7/181; G06V 20/52

(57) ABSTRACT

Methods and systems for monitoring fire extinguishers and their surrounding areas. An example method at least comprises periodically monitoring, with one or more cameras, and one or more of an accelerometer, a weight sensor, and an infrared sensor, a fire extinguisher unit and a surrounding area, providing one or more images of the fire extinguisher unit and the surrounding area to an analysis module after each periodic monitoring, determining, based on the one or more images, whether an internal pressure of the fire extinguisher unit is within a predetermined range of pressures and whether the surrounding area comprises any code violations, and updating a user dashboard based on the determination.

### REFERENCE TO OTHER APPLICATION

The present application claims the benefit and priority of U.S. Provisional Patent Application Ser. No. 63/303,987, filed Jan. 28, 2022.

### FIELD OF THE INVENTION

The invention relates generally to fire safety monitoring, and more specifically to monitoring fire extinguishers.

### BACKGROUND OF THE INVENTION

Internet of things (IoT) devices had first began to emerge in the early 1980s when students had modified a soda vending machine at Carnegie Mellon University. The vending machine had been considered to be the first internet-connected appliance capable of reporting its inventory and informing customers when newly loaded drinks were cold. The term IoT was most likely coined by Procter & Gamble who had used radio-frequency identification (RFID) tags as part of an IoT system. Others have defined IoT as simply the point in time when more ‘things or objects’ are (or will be) connected to the internet than people.

Today IoT has drastically transformed how businesses have operated and how society has functioned in general. As overall communication with IoT has started to become faster with the onset of 5G networks in cities and data generated from connected devices, this has helped businesses in running more efficiently, helped in gaining insight into business processes, and helped in allowing companies in making real-time decisions.

Thus, while IoT has gained in popularity, it appears to have lagged in the field of safety—particularly in areas relating to fire safety monitoring and fire extinguisher inspections. Fire extinguishers typically have been placed in standby condition at stations found throughout facilities at various locations for easy access in a fire emergency. Standards and procedures for routine inspection of fire extinguishers at fire extinguisher stations in the United States have been and are set forth by the National Fire Safety standards established at various levels of government, such as local, state and federal.

While inspections often have been performed manually and have required a dedicated person to walk to every station within a facility to collect notes, more recently fire extinguisher monitoring has been capable of remote, and even automated, performance over the Internet. Thus, whereas before in large facilities inspections had taken days, as there have been hundreds of extinguisher stations to examine, more recently monitoring has been ongoing and controlled by electronic monitoring systems.

Whereas procedures for more frequent inspections have been generally considered cost prohibitive, even where it has been recognized that a problem of numbers of missing or non-functioning fire extinguishers may not have been addressed for days or even weeks at a time, even where manpower may otherwise may have been available, more recently monitoring has been able to be performed more efficiently, it being the case that inefficient monitoring has led to potential safety hazards should a fire have occurred without an extinguisher having been present, having been faulty, of having been not full.

Thus, for example, U.S. Pat. No. 9,609,287 to McSheffrey et al., for Remote Monitoring, discloses remote monitoring and inspection of measurement devices, emergency equipment, and surrounding areas, by using image sensors (e.g., a CMOS camera) to capture an image containing information about the monitored item. A signal containing information about the image (e.g., data representing the captured image or data indicating the state of the captured image) is transmitted to a remote central station, such as a remote server implemented as a laptop computer, a desktop computer, or a single-board computer such as a cellular telephone or a PDA, etc., via a cellular modem, a satellite modem, or a public switched telephone network.

The remote monitoring device of McSheffrey et al. does not teach the use of a motion detection sensor such as a gyrometer, accelerometer, or gyroscope, to detect movement of a fire extinguisher itself, or a door to the cabinet for the fire extinguisher, and it does not teach the use of a weight sensor to detect the weight of the fire extinguisher to see whether the weight has decreased below a specified value considered as sufficiently full. This limits the types of detection the prior art device can do. Further, while the prior art system allows for reporting and analyzing of status of pressure of a fire extinguisher to a central location, it does not specifically teach a software for enabling users in monitoring of motion of the extinguisher itself as well as the weight thereof, either as a means to save power in targeting monitoring, or otherwise. Therefore, it would be advantageous if a system and method of inspecting fire extinguishers used such sensors in addition to a camera for detecting the status of the pressure gauge of a fire extinguisher. Further, it would be advantageous if a system and method of inspecting fire extinguishers used software for monitoring of accelerometer motion of the fire extinguisher or cabinet door for the fire extinguisher or for sensing and monitoring the weight sensing of the extinguisher itself.

### SUMMARY OF THE INVENTION

Embodiments and aspects of the present disclosure are described below in the context of a fire extinguisher monitoring system arranged to provide end users status information about their fire extinguishers and the area surrounding the fire extinguishers. For example, a fire extinguisher cabinet comprises a number of sensors positioned to monitor various aspects of a fire extinguisher, such as weight, movement, internal pressure, and/or an area surrounding the fire extinguisher. Data from the various sensors is provided to an analysis module that determines the state of the fire extinguisher and the surrounding area and provides updates on the status to one or more end users.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present, or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Thus, in accordance with an aspect and embodiment of the disclosure, there is provided a method comprising:
periodically monitoring, with one or more cameras, a fire extinguisher unit, whether enclosed in a cabinet or not, and a surrounding area;
providing one or more images of the fire extinguisher unit and the surrounding area to an analysis module after each periodic monitoring;
determining, based on the one or more images, whether an internal pressure of the fire extinguisher unit is within a predetermined range of pressures and whether the surrounding area comprises any code violations; and
updating a user dashboard based on the determination.

Preferably, in accordance with an aspect and embodiment of the disclosure, the method further comprises: monitoring, with a weight sensor, the fire extinguisher unit, and periodically providing a weight of the fire extinguisher unit to the analysis unit for enabling further determining whether the fire extinguisher has been one of partially and fully discharged. Thus, the method provides for determining, based on the weight of the fire extinguisher unit, whether the fire extinguisher unit is within a range of a predetermined weight range (as for example by comparing the detected weight of the fire extinguisher unit with a reference weight of a full fire extinguisher unit), wherein the predetermined, or reference, weight range is associated with a fire extinguisher unit including a code required amount of fire retardant.

Still further, preferably, in accordance with another aspect and embodiment of the disclosure, the method comprises a step of monitoring, with an accelerometer, for movement of the fire extinguisher unit, and providing indication of movement to the analysis module when movement is detected, to allow for providing an alert, inclusion in a database, or other relevant activity, such as notifying emergency personnel.

In accordance with another aspect and embodiment of the disclosure, the method further comprises monitoring the surrounding area with one or more cameras, providing one or more images of the surrounding area to the analysis module, determining, based on images of the surrounding area, whether one of an emergency and a code violation exists, and updating the user dashboard, such as may be accessible via a web-based portal, as to whether one of an emergency and a code violation exists.

In accordance with an embodiment of the disclosure, the method preferably comprises sending a user an alert based on the aforementioned determination of whether an emergency or code violation exists. Such an alert may be sent using any one or more of a Short Message Service (SMS) message, an email, or other known electronic message.

Thus, further, in accordance with an aspect and embodiment of the disclosure, there is provided a system for monitoring fire extinguishers, comprising:
at least one camera adapted for monitoring a fire extinguisher unit, whether enclosed in a cabinet or not, and a surrounding area of the fire extinguisher unit,
an analysis module, wherein the at least one camera is further adapted for providing one or more images of the fire extinguisher unit and the surrounding area to the analysis module after a periodic monitoring, wherein the system is further adapted for determining, based on the one or more images, whether an internal pressure of the fire extinguisher unit is within a predetermined range of pressures, whether the surrounding area comprises any code violations, and wherein the system if further adapted for updating a user dashboard based on the determination.

Preferably, in accordance with an aspect and embodiment of the disclosure, the system further comprises: a weight sensor adapted for monitoring the weight of the fire extinguisher unit and adapted for periodically providing a weight of the fire extinguisher unit to the analysis unit, for enabling further determining of whether the fire extinguisher has been one of partially and fully discharged. Thus, the system facilitates determining, based on the weight of the fire extinguisher unit, whether the fire extinguisher unit is within a range of a predetermined weight range (as for example by comparing the detected weight of the fire extinguisher unit with a reference weight of a full fire extinguisher unit), wherein the predetermined, or reference, weight range is associated with a fire extinguisher unit including a code required amount of fire retardant.

Still further, preferably, in accordance with another aspect and embodiment of the disclosure, the system comprises an accelerometer adapted for monitoring movement of the fire extinguisher unit, or one or more portions of a fire extinguisher cabinet, and providing indication of movement to the analysis module when movement is detected, so as to allow for providing an alert, inclusion in a database, or other relevant activity, such as notifying emergency personnel.

In accordance with another aspect and embodiment of the disclosure, the system further comprises a camera for monitoring the surrounding area, adapted for providing one or more images of the surrounding area to the analysis module for determining, based on images of the surrounding area, whether one of an emergency and a code violation exists, and updating the user dashboard, such as may be accessible via a web-based portal, as to whether one of an emergency and a code violation exists.

In accordance with an embodiment of the disclosure, the system comprises a networked computer adapted for receiving, and possibly forwarding, a user alert based on the aforementioned determination of whether an emergency or code violation exists. Such an alert may be sent using one or more of an SMS message, an email, an automated phone message, or other known electronic message to, and optionally from, the networked computer.

In accordance with an aspect and embodiment of the disclosure, the first camera is arranged to image a pressure gauge of the fire extinguisher unit.

In accordance with another aspect and embodiment of the disclosure, a second camera, or other sensor such as an infrared sensor, is arranged to image the surrounding area, the surrounding area including at least a six-foot radius arc or circle surrounding the fire extinguisher unit.

In accordance with an aspect and embodiment of the disclosure, the analysis module is connected to the one or more cameras and the user dashboard through one or more of wi-fi, a local area network, a wide area network, a cellular network, and a satellite network, and the analysis of the one or more images may comprise analysis using a machine learning module trained for image segmentation, such as for example to enable better detection of obstructions in front of the fire extinguisher unit or for better detection of the location of a needle on a gauge of a fire extinguisher unit. The first camera may be mounted inside a cabinet to a glass front surface of the cabinet and positioned to image a pressure gauge of the fire extinguisher unit, or it may be held by, or fixed to, a bracket otherwise attached to or near the fire extinguisher unit. The second camera may be mounted either inside, or outside of the cabinet, to image the surrounding area.

A transceiver unit of the overall system may be included within, or outside, of a fire extinguisher cabinet to receive and provide information between components (e.g., the cameras, the weight sensor, the accelerometer) within, or adjacent, the cabinet and the analysis unit, wherein the transceiver unit may be connected to one or more of the first and second cameras, the weight sensor, and the accelerometer, either through a wire or wirelessly, for the purpose of aggregating sensed, or captured, data from the fire extinguisher and cabinet with data from other fire extinguishers (with or without cabinets) in a central data repository for purposes of enabling analysis and reporting to users and/or emergency responders. Thus, a fire safety monitoring device (of potentially many such devices) may be either affixed to, or arranged adjacent to, an extinguisher station or cabinet, and it transmits extinguisher status to a private network that can be viewed by an end user, e.g., a facility manager, or an emergency responder.

The devices herein disclosed and described provide a solution to the shortcomings in the prior art through the disclosure of a system and method for inspecting fire extinguishers automatically. An object of the disclosed techniques is to improve fire safety within a facility. Performing automatic fire extinguisher inspections is much faster and less costly to perform than manual inspections. These savings can allow facilities to perform inspections more frequently and maintain a higher level of extinguisher reliability leading to a safer work environment.

Another object of the disclosed techniques is to allow inspections to take place remotely and in real time.

Another object of the disclosed techniques is to allow users to program when a facility-wide, extinguisher inspection will take place and how it will take place using software that is part of the inspection system. For example, a user can login to the fire safety monitoring device software, review their extinguisher inventory and schedule automatic inspections to take place every month and then set inspections in hazardous areas to take place every week.

Another object of the disclosed techniques is to allow fire extinguisher pressure to be determined automatically. The fire safety monitoring device comprises one or more cameras positioned to image the fire extinguisher's pressure gauge and transmits this image to the fire safety monitoring device's private cloud network. Algorithms analyze the image and determine if the pressure in the extinguisher is satisfactory.

Another object of the disclosed techniques is to inform facility personnel immediately if an extinguisher pressure is too low. Once the fire safety monitoring device has analyzed extinguisher images, it then makes a determination regarding the status of the extinguisher. If the system determines the extinguisher pressure is too low, it notifies personnel of the problem via text message, email, or voice mail according to their notification preferences.

Another object of the disclosed techniques is to allow users to be notified if a fire extinguisher is being used or is being tampered with. Each fire safety monitoring device contains a sensor that detects the presence of an extinguisher and a vibration detection unit, e.g., an accelerometer, that detects vibrations associated with extinguisher movement. If the unit is activated, the user is notified immediately to help them take appropriate action.

Another object of the disclosed techniques is to allow users to generate fire extinguisher status reports. The fire safety monitoring device software stores inspection data and the interface allows users to generate summary reports according to their preferences such as weekly, monthly, and annual inspection reports in preparation for potential OSHA reporting requirements.

The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present.

The subject matter of the present invention is particularly pointed out and distinctly claimed in the concluding portion of this specification. However, both the organization and method of operation, together with further advantages and objects thereof, may best be understood by reference to the following descriptions taken in connection with accompanying drawings wherein like reference characters refer to like elements.

### BRIEF DESCRIPTION OF THE DRAWINGS

FIGS. 1A-1C illustrate communications of alerts to a computer, a smart phone, and/or a tablet computer, all in accordance with embodiments of the present disclosure;

FIGS. 2A and 2B show an example of a fire safety monitoring device and location in a fire extinguisher case in accordance with an embodiment of the present disclosure;

FIG. 3 is a logic and functional diagram of a fire monitoring system and remote server system in accordance with an embodiment of the present disclosure;

FIG. 4 is another example of a fire safety monitoring system in accordance with an embodiment of the present disclosure;

FIGS. 5A and 5B are examples of a fire safety monitoring device in accordance with an embodiment of the present disclosure;

FIG. 6 is an example method of operating a fire safety monitoring system in accordance with an embodiment of the present disclosure;

FIG. 7 is an example functional block diagram of a computing device that may be implemented in a fire safety monitoring device and system in accordance with an embodiment of the present disclosure;

FIG. 8 is a perspective front view of an embodiment of a fire safety monitoring device, such as may be used for monitoring a fire extinguisher;

FIG. 9 is a rear view of the fire safety monitoring device of FIG. 8;

FIG. 10 is a perspective view of a bracket having a fire safety monitoring device (e.g., the fire safety device of FIGS. 8 and 9) retained therein, wherein the bracket and device are adapted for alternatively positioning the fire safety monitoring device directly on a fire extinguisher;

FIG. 11 is another perspective view of the bracket and fire safety monitoring device, with the fire safety device shown retained in the bracket for attaching the fire safety monitoring device and bracket to a fire extinguisher; and

FIG. 12 is a perspective view of an alternative embodiment fire safety monitoring device, also shown in a bracket for attachment to a fire extinguisher, wherein the alternative embodiment fire safety monitoring device has both a camera facing toward the fire extinguisher, and a camera, or other sensor, facing away from the fire extinguisher for monitoring the surrounding area in front of the fire extinguisher.

### DETAILED DESCRIPTION OF EMBODIMENTS

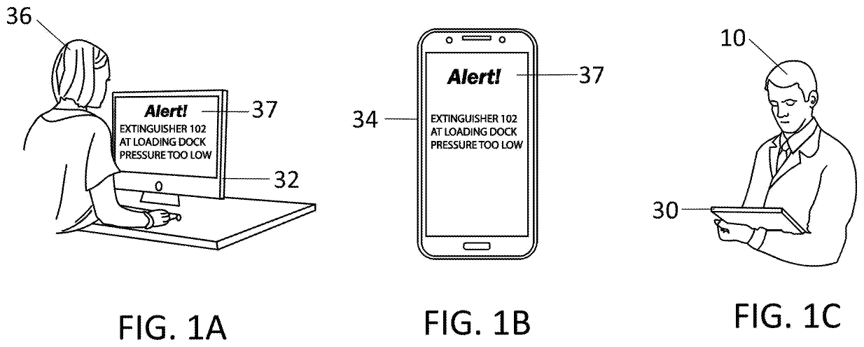

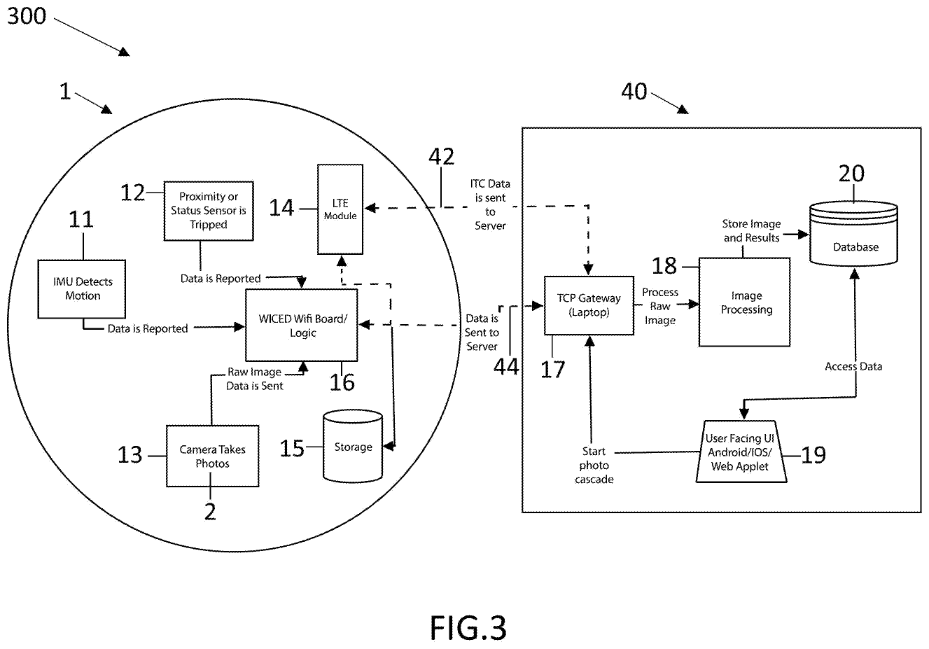

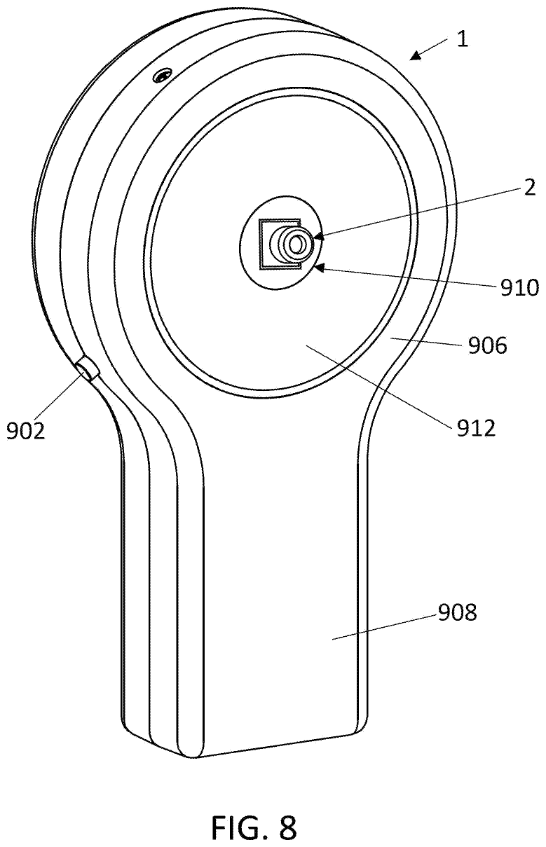

FIGS. 1A, 1B, 1C, 2A, 2B, 8, and 9 show perspective views of an embodiment of a fire safety monitoring device 1 as may be affixed with an adhesive strip 8 to a conventional fire extinguisher cabinet door panel 5 (e.g., made of glass or clear plastic) inside a station, e.g., cabinet, 3 in accordance with an embodiment of the present disclosure. The fire safety monitoring device 1 comprises an onboard camera module 2 that reads pressure gauge 4 included with a fire extinguisher 6 within the cabinet 3. As shown further in FIG. 3, the fire safety monitoring device 1 comprises an internal controller board such as, but not limited to, a WICED™ WiFi Board/logic and Arduino™, and the like, having a wireless transmitter for sending wireless signals to one or more computing devices (e.g., tablet computer 30, desktop computer 32, or mobile phone device 34) used by stakeholders 36, 10 via a cloud network as further described below using methods including but not limited to WiFi, cellular networks, etc., and notifying the stakeholders of extinguisher 6 status and emergency alerts using software application 37 residing on the computing device(s) 30, 32, 34.

A body portion 906 of the device 1 is adapted to housing the electronics of the device (e.g., one or more cameras, an accelerometer, an infrared device, a microcontroller, memory, communications interface, etc., all as further described herein). Two small buttons 902, 904 are provided on an upper external periphery of the device. The first button 902 is for resetting/waking up—or booting/forced restart of the device 1, for example when the button is held down when newly installing the device. Further, this button may be programmed with a single quick press to snap a photograph. The second button 904 may be programmed to manually record an inspection by a user 10, 36. In a “handle” portion 908 of the device 1, there is provided a compartment for retaining preferably a 9-volt battery 900 therein for powering the device. One or more of the body portions 906 and 908 may be separated, or separable, to allow for easy access to and changing of the battery 900.

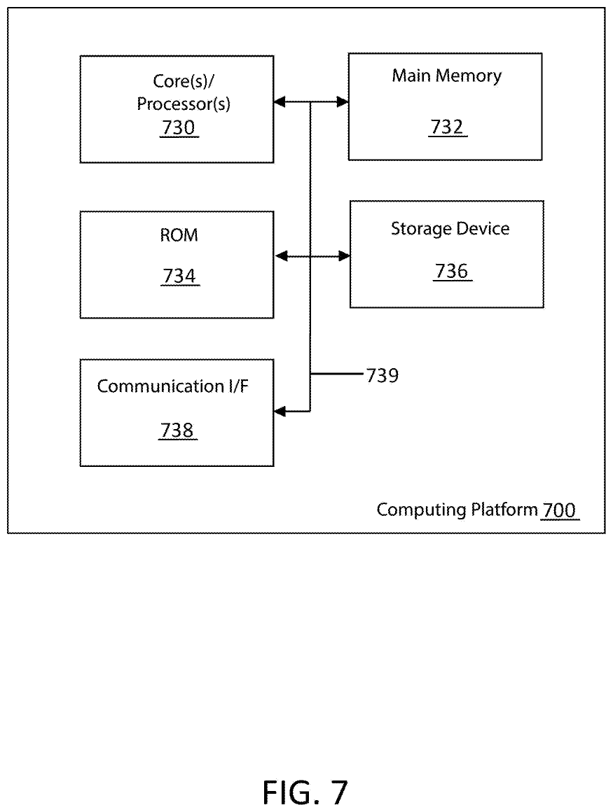

As shown in detail in FIG. 8, there is provided a circular area 910 in the plastic or glass surface 912, wherein the glass is very clear to allow for the camera 2 to obtain good-quality images. The rest of the glass 912 around the circular area 910 may be “frosted” or otherwise obscured as shown such that LED lights behind this area do not overly flood the area to be photographed with too much light.

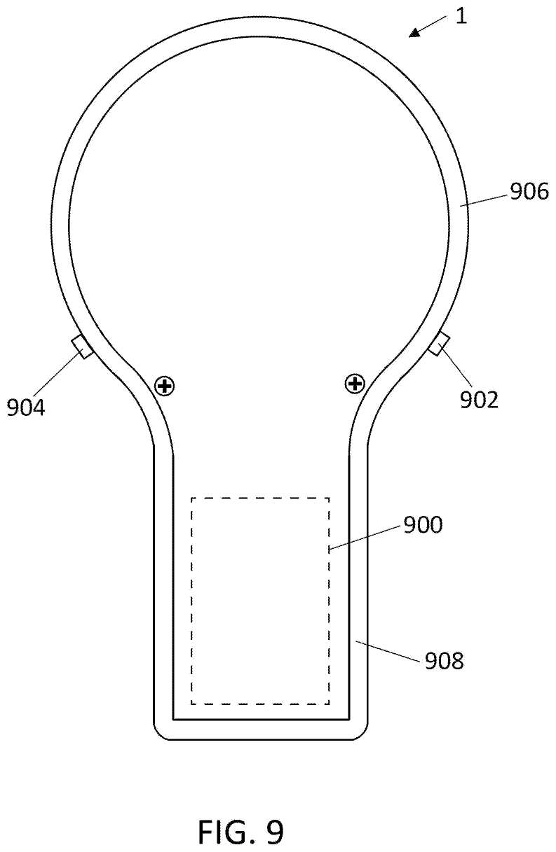

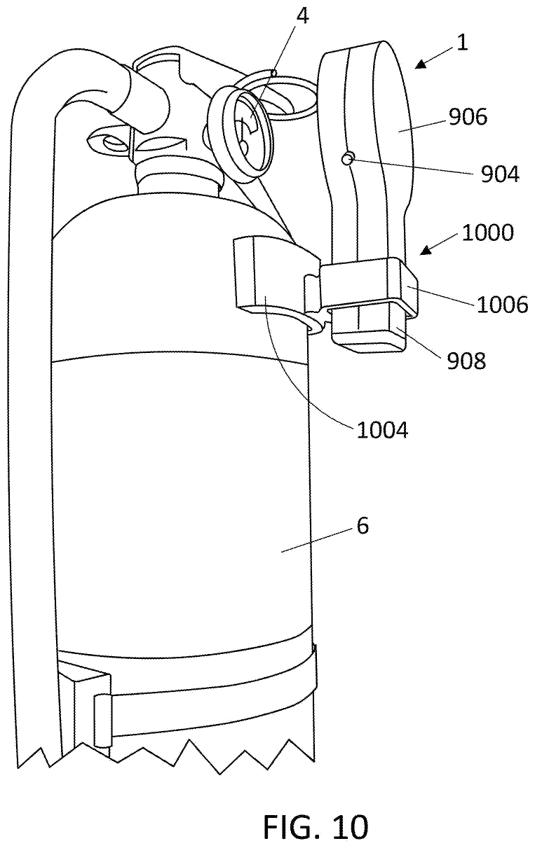

Referring now to FIGS. 10-11, there is shown an alternative embodiment of means for attaching the device 1 to a fire extinguisher 6. Thus, there is provided a bracket 1000 with magnets 1002 retained in a curved base 1004 adapted for removeably, magnetically, attaching the bracket to the fire extinguisher 6. The bracket further comprises a retaining ring 1006 attached to the base 1004 and adapted for receiving and holding the handle portion 908 of the device 1, and further adapted for retaining the device 1 in close proximity to the gauge 4 of the fire extinguisher 6 to readily enable taking photographs of the gauge to monitor readiness of the fire extinguisher.

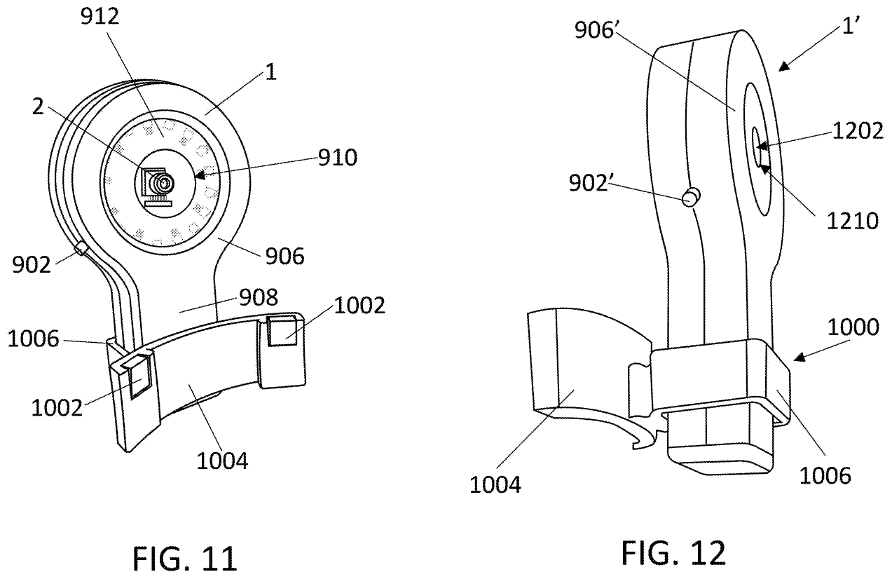

Referring now to FIG. 12, there is shown another alternative embodiment of the device 1′, wherein either two cameras 2, 1202 are retained in the upper body portion 906′ of the device, or a camera 2 and an infrared/laser sensor 1210 are retained in the upper body portion 906′ of the device, such that one camera is adapted to capture images of the gauge 4 of the fire extinguisher 6, while the other camera, or infrared/laser sensor, is adapted to monitor (either by capturing an image or sensing) in the surrounding area 228 around the fire extinguisher. Thus, in this embodiment, the entire system (including even an accelerometer 11, 106) may be housed in a single device 1′.

FIG. 3 shows an embodiment of a logic and functional diagram of a fire safety monitoring system 300 with a monitoring device 1 and a remote server cloud processing system 40. The monitoring device 1 comprises, in an embodiment, data monitoring devices, such as an accelerometer 11, a proximity and/or alphanumeric status sensor 12, and a camera 2. The remote server cloud processing system 40 comprises server components, such as a TCP Gateway/Computer 17, an image processing unit 18, and a storage database 20. FIG. 3 shows a representative view of the fire safety monitoring system 300, wherein the device's 1 camera module 2 is adapted for taking digital photos 13 of pressure gauges 4 of fire extinguishers 6, such as for example at regular intervals (such as hourly, daily, weekly, or monthly—depending on requirements and compliance regulations—and according to software or firmware control) and transmitting, or reporting, them to an internal controller board 16. Further, a motion detector 11 (such as an inertial measurement unit (IMU), or accelerometer) and a proximity sensor 12 (such as an infrared, or laser, detector) are preferably provided (whether in device 1 or separately within a fire extinguisher cabinet 5), both for transmitting, or reporting, monitoring data to the controller board 16 to alternatively trigger taking of digital photos 13, or for independently transmitting and storing motion data and/or proximity data for later use and/or analysis. It will be appreciated that other means of determining pressure, or of determining a change in status, such as an alphanumeric status sensor, for reading a digital pressure gauge or other digitally-reported status relating to a fire extinguisher, may also be employed as part of monitoring system described herein without departing from the invention as broadly claimed.

Such monitoring data, such as photographs, motion detection data, proximity data, and any other sensed data, of the system 1 is sent to the internal controller board 16 for storage in a local storage device 15 (such as local ram memory), and in turn the monitoring data is transmitted from the local memory for transmission wirelessly via an LTE module 14 (such as a wireless broadband transmitter), or cellular technology such as 4G or 5G (fourth generation or fifth generation cellular phone service), to a secure, cloud network server 40, or other local or remote computerized system for processing and storage. The aforementioned wireless transmissions are received at the server 40 gateway 17 (e.g., a laptop or desk top computer) via a cloud network 42, 44 for analysis and image processing 18. In turn, after processing, the monitoring data from the server 40 may be forwarded via the cloud network 42, 44 to stakeholders 10, 36, for example via a photo cascade sent by means of a user interface 19 to computers 30, 32, 34. The monitoring data may also be sent by the image processing unit 18 to a database 20, for storage and management according to data storage protocols and so as to be readily available and accessible when necessary for future review and reporting. Excess stale data, as determined in accordance with current compliance regulations, may be deleted from the database to conserve server storage bandwidth where possible or necessary.

A mobile application is provided by techniques known to those of skill in the art using hardware, languages, and development environments known in the art. Those of skill in the art will recognize that mobile applications are written in several languages and include, by way of non-limiting examples, C, C++, C #, Objective-C, Java™, Javascript, Pascal, Object Pascal, Python™, Ruby, VB.NET, WML, and XHTML/HTML with or without CSS, or combinations thereof. Such software may be provided so as to be compatible with a plurality of operating systems such as, but not limited to: Windows®, Apple®, and Android®, and compatible with a multitude of hardware platforms such as, but not limited to: personal desktops, laptops, tablets, smartphones and the like. Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available such as, by way of non-limiting examples, Lazarus, MobiFlex, MoSync, and Phonegap. Also, mobile device manufacturers distribute software developer kits including, by way of non-limiting examples, iPhone® and iPad® (iOS) SDK, Android® SDK, BlackBerry® SDK, BREW SDK, Palm® OS SDK, Symbian SDK, webOS SDK, and Windows® Mobile SDK.

Those of skill in the art will recognize that several mobile applications are available from several commercial forums, including, by way of non-limiting examples, Apple® App Store, Google® Play, Chrome Web Store, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, a computer program comprises a standalone application, which is a program that is run as an independent computer process, not an add-on to an existing process, e.g., not a plug-in. Those of skill in the art will also recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program comprises one or more executable complied applications. In some embodiments, the computer program comprises a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof. Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Microsoft Edge®, Mozilla® Firefox®, Google Chrome®, Apple Safari®, Opera Software®, and KDE Konqueror. In some embodiments, the web browser is a mobile web browser. Mobile web browsers (also called micro-browsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm®, WebOS® Browser, Mozilla®, Firefox® for mobile, Microsoft® Internet Explorer® Mobile, Amazon® Kindle® Basic Web, Nokia® Browser, Opera Software®, Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, users may have access to functions such as, but not limited to, account registration (contact information, subscription payments, notification preferences, etc.); fire safety device registration (e.g., pairing the various compatible sensors up to the network); and defining fire safety device operating parameters (when to power on, how long to remain active, when to engage local area networks and transmit data, etc.). The operating software may also be compatible with a plurality of operating systems such as, but not limited to: Windows®, Apple®, and Android®, and compatible with a multitude of hardware platforms including, but not limited to: personal desktops, laptops, tablets, smartphones and the like. The fire safety device embodiments described herein may also have an identifier on the logistics system, which is used when collecting and transmitting data according to user presets and sending alerts (errors, emergency threshold breaches, etc.) to the logistics system as necessary and to the end user. Thus, an end user 10, 36 may have a plurality of monitoring devices 1 associated with their account, wherein each device is associated with a specific fire extinguisher 6 that is listed in their account. Data associated with each fire extinguisher 6 is stored in database 20 and is accessible to the operating software as needed to update a user's 10, 36 dashboard and for transmitting alerts to associated end users.

In some embodiments, device 1 is electrically connected to the back-end management system by means of a cloud network 40, 42, 44, where the cloud network comprises algorithms and routine operations such as but not limited to: subscription services (user demographics, sensor registrations etc.); online payments (venom, paypal etc.); administrative operations (website backend management, sensor data account archives, etc.); selective parameters available for fire safety monitoring devices (power on time, dormant mode, time presets, transmission schedules, transmission rates, etc.); notifications (emergency alerts, dynamic shipping alerts, etc., via text messages SMS, email and the like); and encryption (such as advanced encryption standard, rivest-shamir-adleman (RSA), and triple data encryption standard, etc.). The logistics software may also preferably comprise the capability to transfer power and bandwidth software parameters either remotely (wirelessly) or by means of localized USB cables etc.

In general, fire safety device 1 is configured to monitor a fire extinguisher 6 to ensure the pressure of the fire extinguisher is within the required range so that the extinguisher is ready in case of an emergency. Additionally, the remote monitoring of one or more fire extinguishers 6 reduces the manpower used to manually check those same fire extinguishers on a periodic basis. Further, fire safety system 300 with fire safety device 1 (or fire safety device 1′ as further described herein) may monitor an area 228 around the fire extinguisher 6 to ensure code violations are remedied before an emergency occurs, such as the path to a fire extinguisher being unlawfully blocked.

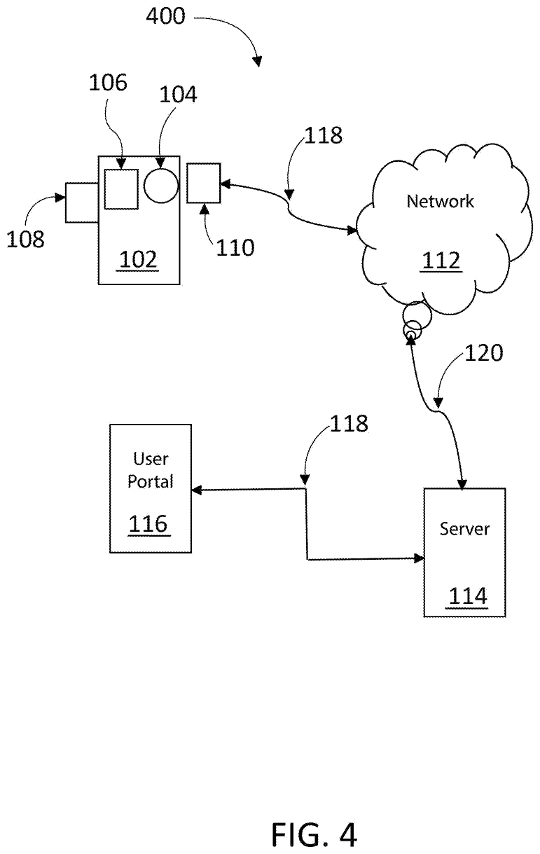

FIG. 4 shows another alternative fire safety monitoring system 400 in accordance with an embodiment of the present disclosure. The fire safety monitoring system 400, which may simply be referred to as system 400 herein, is arranged to monitor the status of one or more fire extinguisher units 6 regardless of relative location. The system 400 may additionally monitor the fire safety status of the surrounding area 228 of the fire extinguisher unit 6 and provide information to a central processing area, which may make further analysis and determinations that are provided to a user dashboard 37 and/or sent as alerts to end users 10, 36. A plurality of fire extinguishers 6 located in a large complex, multiple complexes, or across multiple locations may be monitored and their respective data tracked for each fire extinguisher 6 by system 400. Due to the man hours involved in the conventional monitoring and testing of fire extinguishers, system 400 may result in considerable cost savings allowing companies to use their man hours otherwise.

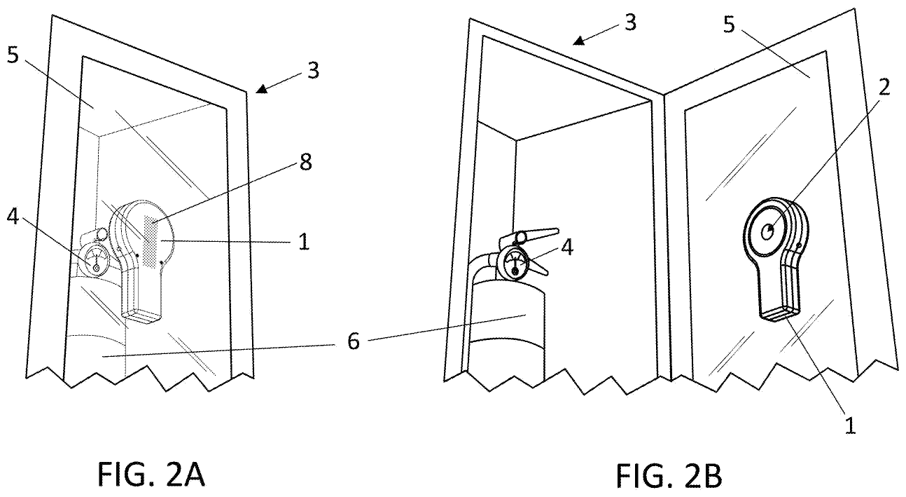

As shown in FIG. 4, system 400 preferably comprises a fire safety monitoring device 110, a network 112, a server 114, and a user portal 116. The fire safety monitoring device 110 is arranged to monitor a fire extinguisher unit 102 and an area surrounding the unit 102, and comprises one or more cameras (not shown in FIG. 4, but for example as shown in FIGS. 2A, 2B, 5A, 5B, 8, 11, and 12) that are arranged to monitor a pressure gauge 104 of fire extinguisher unit 102 and the area surrounding the unit 102. Device 110 additionally may comprise separate components 106 and 108, which monitor movement and the weight of unit 102, respectively. For example, an accelerometer 106 may be positioned on the unit 102 to monitor for movement of the unit 102, and a weight sensor 108 may be positioned to weigh the unit 102. The various components of unit 110 may be electrically coupled to one another or with a base, such as device 110, via one or more wires, or wirelessly, such as Bluetooth or near field communication (NFC), so that data and control can be provided between the various components 110, 106, and 108 and the server 114. Further, these components 106 and 108 may be combined into a single unit together with one or more cameras 2, without departing from the scope of the invention as claimed.

Network 112 may be any wired or wireless network and is used to provide information and instructions from the safety monitor device at the location of the unit 102 and the server 114. The network 112 may simply be a wi-fi network, a local area network (LAN), a wide area network (WAN), a cellular network, a satellite network, or combinations thereof. The network 112 is included to provide a communication path between one or more fire safety monitor devices 110 and the server 114. Data may be transmitted between devices 110 and server 114 periodically or continuously so that changes at the fire safety monitor device 110 relating to emergencies and/or code violations can be caught, and alerts and information sent to end users.

Server 114 may be located in the cloud, for example, and be formed from one or more instances of management and analysis software configured to at least receive data, make determinations regarding various scenarios of a fire extinguisher 6, 102 and its surrounding area 228 (e.g., such as fire, low extinguisher pressure, blockage of access, or other code violation), and provide updates to an end user 10, 36 via user portal 116 and/or sending direct alerts to end users. The direct alerts can be made using SMS messaging, emails, automated phone calls, or other methods of messaging now known or unknown. The number and type of messages may be changed based on a severity of an emergency or status change. For example, a fire may cause server 114 to alert an end user 10, 36 using all selected forms of alert mechanisms, whereas a low pressure on a fire extinguisher may only result in a flag on the user portal.

Server 114 may be formed of a number of functional code blocks that perform various processes for monitoring fire extinguishers 6, 102 and updating associated end users 10, 36. For example, there may be a functional code block for managing data receipt and data output, a block for managing data analysis, and a block for managing software updates to devices 110. Of course, other code blocks may be included and added over time.

User portal 116 may be a web-based user interface that end users 10, 36 access to understand the status of their associated fire extinguisher units 6, 102. The user portal 116 may include software code configured to generate and present a dashboard 37 to each user 10, 36 where each user's dashboard will show the status of fire extinguishers for that user. For example, the dashboard 37 may provide the status of such variables as the pressure, weight, and movement of each fire extinguisher 6, 102, and the status of the area surrounding each fire extinguisher unit. The size of the surrounding area 228 may be dictated by local, state and/or federal safety codes, which may require the surrounding area to be free from debris blocking access to the fire extinguisher 6, 102. The other variables may inform the end user whether the fire extinguisher 6, 102 should be replaced or inspected if movement has been indicated by the motion sensor/accelerometer 106. In some examples, movement indicated by the accelerometer 106 may cause the device 110 to turn on cameras 2 to determine if the movement is in response to an emergency, e.g., fire, or whether the fire extinguisher 6, 102 was wrongly moved or taken.

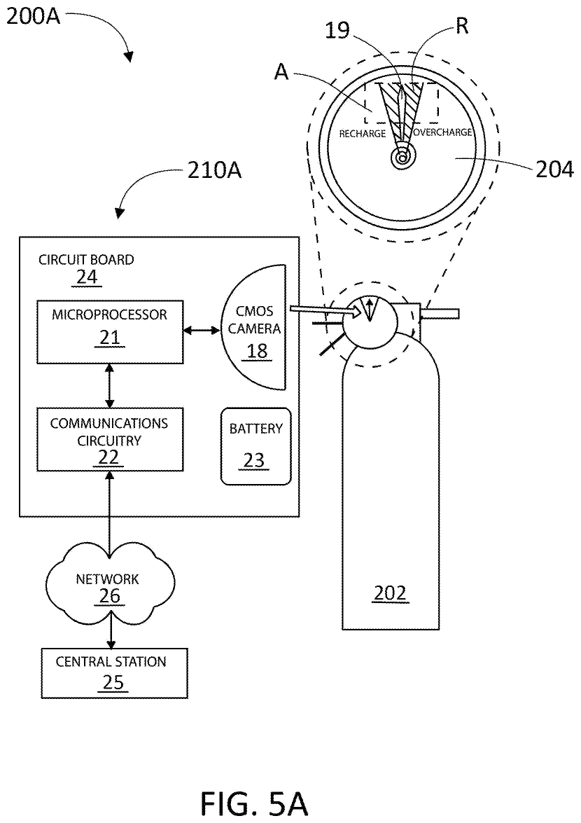

In concert, system 400 performs the following tasks to understand the status of a fire extinguisher unit 6, 102 and its surrounding area 228 and to inform an associated end user of the status. For example, a device 110 may periodically acquire an image of a pressure gauge 104 and a surrounding area 228 (see, e.g., FIG. 5) of a fire extinguisher unit 6, 102. Additionally, device 110 may receive weight information and movement information from units 108 and 106, respectively. All of such monitoring data may then be transmitted to server 114 via network 112, which is coupled to device 110 via wired or wireless connections 118 and 120.

Server 114 may then initiate an analysis module to analyze the received data. The images may be analyzed by a trained model using image segmentation in a process of partitioning digital images into multiple image segments, also known as image regions or image objects or sets of pixels. This, in turn enables simplified analysis of objects and boundaries of obstructions detected in the images. Thus, for example, image segmentation may be used to more accurately determine whether the pressure of the unit 6, 102 is within a desired range and further determine if any obstructions to the unit are within the surrounding area 228. The analysis further comprises comparing the weight to a threshold to ensure an amount of fire retardant within the unit 6, 102 is within range. Lastly, any movements indicated by the movement data are stored, and all data is stored and provided, or made available for further analysis by the system and to the user portal 116. An end user 10, 36 may then access their dashboard 37 through the user portal 116 to review the status of all of their fire extinguisher units 6, 102 and the surrounding area 228. Still further, automated alerts may be provided to users to maintain fire extinguishers 6, 102 based on alert status.

Referring to arrangement 200A of FIG. 5A, a sensor device 210A, which is one example of device 110 of FIG. 4, at least comprises a camera 18, a microprocessor 21, communications circuitry and antenna 22, and battery 23 all mounted to a circuit board 24. The camera 18 is positioned to capture images of at least the pressure gauge 204 of the fire extinguisher unit 202, such as area A, which displays whether the indicator needle 19 is within the desired pressure range (e.g., shaded region R) or outside the desired pressure range. Battery 23 supplies power to the camera 18 and other components on circuit board 24. In some examples, device 210A may be electrically coupled to a wire outlet and, as a result, battery 23 would be used as a backup power source in moments of a power outage.

Communications circuitry 22 provides two-way communication between the sensor device 210A and a remote central station 25 using a network 26 (e.g., a wireless IEEE 802.15.4-compliant or IEEE 802.11-compliant wireless network, Ethernet network, etc.) Microprocessor 21 periodically triggers the camera 18 (and/or sensor 210A) to periodically capture an image of the pressure gauge 204. In some examples, microprocessor 21 can be configured or programmed to recognize a state of the pressure gauge based on an analysis of the image and transmit a signal to the remote central station indicating the recognized state. In other examples, sensor device 210A transmits the image to the central station where the central station comprises one or more analysis modules to perform the image analysis, such as through image segmentation by a programmed model implemented through machine learning.

The fire extinguisher's pressure gauge 204 has at least two important states: (i) a normal state when the pressure gauge indicates a pressure within the operating limits and a (ii) an out-of-range state when the pressure gauge indicates a pressure outside the operating limits. In most scenarios, the range of what is within operating limits will be set by a government authority, either at a state or federal level. Other implementations may recognize other states, such as a normal state, an above-normal state and a below-normal state. In some examples, an image sensor device may be configured to recognize alpha-numeric characters displayed by a measurement device. For example, if a measurement device has a digital readout, a digital image sensory device may execute optical character recognition (OCR) software to recognize the alpha-numeric characters captured in the digital image, which may be used to determine the state of the fire extinguisher unit 202.

The components of sensor device 210A are logical components, and, in actual implementations, one logical component may be implemented in separate physical components. Similarly, the functionality of multiple logical components may be combined and implemented as a single physical component. For example, an image status sensor device 12 may be implemented with multiple processors, e.g., one processor dedicated for the operation of the image sensor, e.g., camera 18, and a second processor dedicated to recognizing states and/or alpha-numeric characters captured in an image. Similarly, the functionality of communication circuitry 22 and a microprocessor 21 may be combined into a single physical component.

Referring to arrangement 200B of FIG. 5B, devices 210A, 210B are another example of device 110. In arrangement 200B, the fire extinguisher 202 is arranged within a cabinet 224 that is built into a wall 226. The device 210A is arranged inside of the cabinet 224, such as on a wall or door, and is situated to view the pressure gauge 204 using one or more cameras, as discussed above. Device 210B, however, is arranged outside of cabinet 224 so that the surrounding area 228 can be readily monitored. In this example, device 210B also comprises one or more cameras that are aimed to view the surrounding area 228 for any blockage to the fire extinguisher 202. In the example of 200B, an accelerometer and a weight sensor (not shown), such as components 106 and 108, may be built into cabinet 224. In the example of FIG. 5B, the cabinet 224 may include additional power providing circuits (not shown) that provide power to the monitoring components. Additionally, cabinet 224 may also include transceiver hardware to couple the components to a server via a network, such as server 114 and network 112.

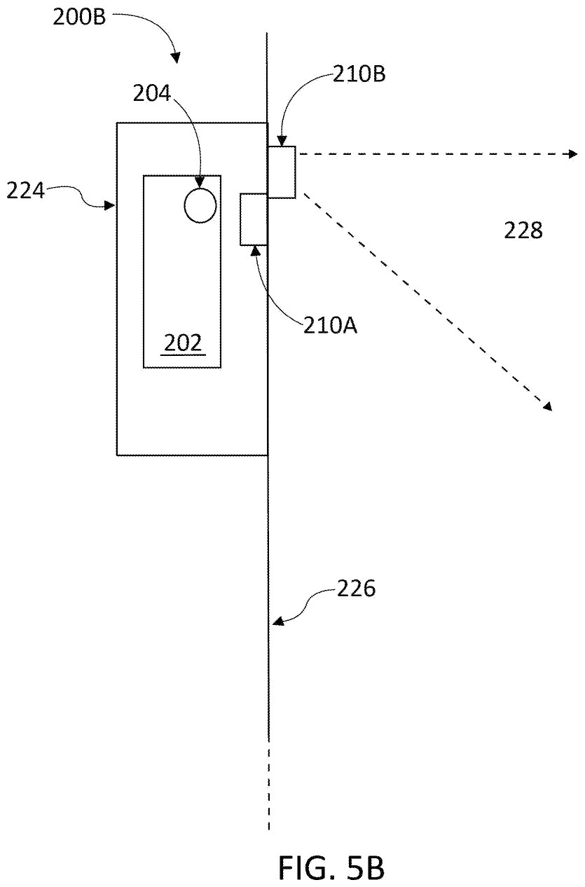

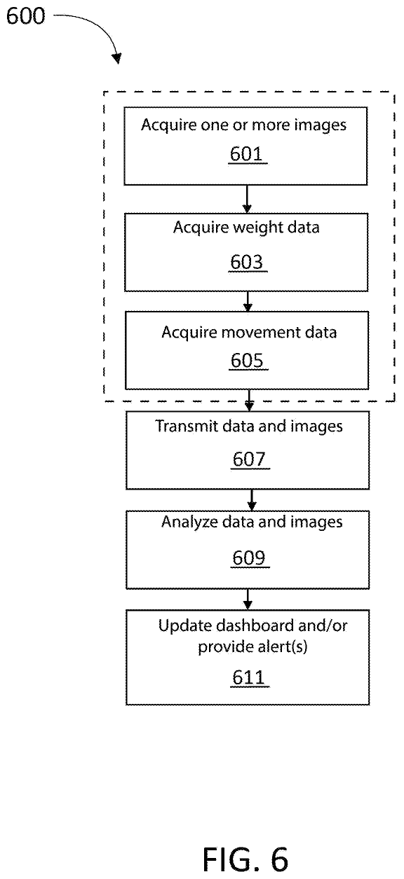

Referring now to FIGS. 6 and 7, FIG. 6 shows a functional diagram of an example method 600 for acquiring and receiving acquired data from any of devices 1, 110, 106, 108, and/or 210A, 210B to be controlled by a computer system 700 shown in FIG. 7, for monitoring a fire extinguisher and its surrounding area in accordance with an embodiment of the present disclosure. The system 700 may thus receive acquired data from devices 1, 110, 106, 108, and/or 210A, 210B, for example. System 700 performing method steps 607 to 611 of FIG. 6 results in determination of the status of a fire extinguisher and its surrounding area and in updating an end user file or dashboard 37 of the determined status.

The system 700 processes the method 600 beginning at process block 607, and the method 600 also comprises receiving acquired monitoring data (at process blocks 601, 603, 605) from subsystems, such as cameras 2, weight sensors 108, and motion sensors/accelerometers 106, relating to a fire extinguisher 6, 202 and its surrounding area 228. For example, cameras in devices 210A and 210B may acquire an image of a fire extinguisher pressure gauge 204 and the surrounding area 228, respectively, and these images may then be received at process block 601.

Process block 601 may be followed by process block 603, which comprises acquiring and receiving acquired weight data of the fire extinguisher 6, 202. For example, weight sensor 108 may be used to acquire the weight of the fire extinguisher unit 6, 202.

Process block 603 may be followed by process block 605, which comprises acquiring and receiving acquired movement data. For example, accelerometer 106 may provide any logged movement data of a fire extinguisher 6, 202 or cabinet door 5.

It should be noted that process blocks 601, 603 and 605 may be performed concurrently or in any order desired by their respective components 1, 106, 108, 110, 210A, 210B, and the sequence shown in FIG. 6 is not dispositive. Additionally, the acquisition of the images and other data, e.g., weight and movement data, may occur periodically based on user settings, or may occur due to received instructions from operating software located at a server, such as server 114, or local microprocessor. For example, if a fire alarm occurs at a location that comprises one or more fire extinguishers 6, 202 having devices 1, 1′, 110 (for example), then the operating software may transmit a message to the devices at the location instructing the devices to acquire images so that data regarding the fire alarm may be acquired. Such data may be sent to the end user 10, 36 or a local fire department so that the location and source of the fire alarm can be determined and addressed as desired.

Process blocks 601, 603 and 605 may be followed by process block 607, which comprises transmitting the one or more images and the data to the server. For example, device 1, 1′, or 110 may receive the weight and movement data from the respective sensors and transmit that data along with the one or more images to the server, such as server 114.

Process block 607 may be followed by process block 609, which comprises analyzing the data and the one or more images. For example, the weight and movement data may be stored in a file associated with the fire extinguisher unit and compared to threshold values of movement and weight and/or compared against prior received data. Any movement data or weight data above or below a threshold may be flagged. Additionally, the one or more images may be analyzed by an analysis unit, which comprises algorithms or machine learning models configured to analyze the images. A machine learning module trained for image segmentation may analyze the images to determine the pressure of the unit and whether there are any obstructions in the surrounding area. The results are then logged in the associated file.

Process block 609 may be followed by process block 611, which comprises updating a dashboard 37 and/or sending alerts to an end user 10, 36. In this step, a dashboard 37 associated with the end user 10, 36 is updated with the status of the fire extinguisher and surrounding area. For example, indications of movement and weight are included in the dashboard 37 and a status of the internal pressure of the fire extinguisher unit and the surrounding area are provided on the dashboard. In some scenarios, if an adverse situation exists, such as low weight, high level of movement, pressure out of range, or an obstruction in the surrounding area are determined, an alert may be sent to the end user 10, 36 using any method disclosed above.

Thus, FIG. 7 is an example functional block diagram of a well-known computer system 700 in accordance with an embodiment of the present disclosure. It illustrates a computer system 700 that an embodiment of the invention may include. The computing system 700 may be an example of computing hardware included with systems, and/or subsystems, 1, 1′, 110, 210A, 210B, 106, 108, and/or coupled servers. A computer system 700 for performing the method 600 at least comprises a bus 739, and other communication circuitry 738, for communicating information, and a hardware processor 730 coupled with the bus 739 for processing information. The hardware processor 730 may be, for example, a general-purpose microprocessor. The computing system 700 may be used to implement the methods and techniques disclosed herein, and it may also be used to obtain images and segment said images into one or more classes.

The computing system 700 comprises a main memory 732, such as a random-access memory (RAM) or other dynamic storage device, coupled to the bus 739 for storing information and instructions to be executed by the microprocessor 730. Such main memory 732 also may be used for storing temporary variables or other intermediate information during execution of instructions to be executed by the microprocessor 730. Such instructions, when stored in non-transitory storage media accessible to the microprocessor 730, render the computer system 700 into a special-purpose machine that is customized to perform the operations specified in the instructions.

Computer system 700 further comprises a read-only memory (ROM) 734 or other static storage device 736 coupled to the bus 739 for storing static information and instructions for the microprocessor 730. A storage device 736 such as a magnetic disk or optical disk, may be provided and coupled to the bus 739 for storing information and instructions.

Computer system 700 may be coupled via bus 739 to a display 32, such as a cathode ray tube (CRT), or Liquid Crystal Display (LCD), or Light Emitting Diode (LED), for displaying information to a computer user 10, 36. An input device 738, including alphanumeric and other keys, is coupled to the bus 739 for communicating information and command selections to the microprocessor 730. Another type of user input device 738 comprises cursor control, such as a mouse, a trackball, or cursor direction keys for communicating direction information and command selections to processor 730 for controlling cursor movement on the display which is also commonly used. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more application specific integrated circuits (ASICs) or field-programmable gate arrays (FPGAs), firmware and/or program logic which in combination with the computer system causes or programs computer system 700 to be a special-purpose machine. According to one embodiment, the techniques herein are performed by computer system 700 (and related data acquisition components, e.g., 2, 106, 108) in response to processor 730 executing one or more sequences of one or more instructions contained in main memory 732. Such instructions may be read into main memory 732 from another storage medium, such as storage device 736. Execution of the sequences of instructions contained in main memory 732 causes processor 730 to perform the process steps described herein. In alternative embodiments, hard-wired circuitry may be used in place of or in combination with software instructions.

The term “storage media” as used herein refers to any non-transitory media that stores data and/or instructions that cause a machine to operate in a specific fashion. Such storage media may comprise non-volatile media and/or volatile media. Non-volatile media comprises, for example, optical or magnetic disks, such as storage device 736. Volatile media comprises dynamic memory, such as main memory 732. Common forms of storage media include, for example, a floppy disk, a flexible disk, hard disk, solid state drive, magnetic tape, or any other magnetic data storage medium, a compact-disc read-only memory (CD-ROM), any other optical data storage medium, any physical medium with patterns of holes, a random access memory (RAM), a programmable read-only memory (PROM), an erasable programmable read-only memory (EPROM), a flash erasable programmable read-only memory (FLASH-EPROM), a non-volatile random access memory (NVRAM), any other memory chip or cartridge, content-addressable memory (CAM), and/or ternary content-addressable memory (TCAM).

Storage media is distinct from but may be used in conjunction with transmission media. Transmission media participates in transferring information between storage media. For example, transmission media comprises coaxial cables, copper wire and fiber optics, including the wires that comprise bus 739. Transmission media can also take the form of acoustic or light waves, such as those generated during radio-wave and infrared data communications.

Various forms of media may be involved in carrying one or more sequences of one or more instructions to processor 730 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infrared transmitter to convert the data to an infrared signal. An infrared detector can receive the data carried in the infrared signal and appropriate circuitry can place the data on bus 739. Bus 739 carries the data to main memory 732, from which processor 730 retrieves and executes the instructions. The instructions received by main memory 732 may optionally be stored on storage device 736 either before or after execution by processor 730.

Computer system 700 also comprises a communication interface 738 coupled to bus 640. Communication interface 738 provides a two-way data communication coupling to a network link that is connected to a local network (e.g., 112 of FIG. 4). For example, communication interface 738 may be an integrated services digital network (ISDN) card, cable modem, satellite modem, or a modem to provide a data communication connection to a corresponding type of telephone line. As another example, communication interface 738 may be a local area network (LAN) card to provide a data communication connection to a compatible LAN. Wireless links may also be implemented. In any such implementation, communication interface 738 sends and receives electrical, electromagnetic or optical signals that carry digital data streams representing various types of information.

The network link typically provides data communication through one or more networks to other data devices. For example, the network link may provide a connection through local network 112 to a host computer or to data equipment operated by an Internet Service Provider (ISP). The ISP in turn provides data communication services through the world-wide packet data communication network now commonly referred to as the “Internet”. The local network and the Internet both use electrical, electromagnetic or optical signals that carry digital data streams. The signals through the various networks and the signals on the network link and through the communication interface 738, which carry the digital data to and from computer system 700, are example forms of transmission media.

Computer system 700 can send messages and receive data, including program code, through the network(s), the network link and communication interface 738. In the Internet example, a server 114 might transmit a requested code for an application program through the Internet using an ISP and a local network 12, and the communication interface 738.

The received code may be executed by processor 730 as it is received, and/or stored in storage device 736, or other non-volatile storage for later execution.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

The embodiments discussed herein to illustrate the disclosed techniques should not be considered limiting and only provide examples of implementation. Those skilled in the art will understand the other myriad ways of how the disclosed techniques may be implemented, which are contemplated herein and are within the bounds of the disclosure.

What is claimed is:

1. A method comprising:
periodically monitoring, with one or more cameras, a fire extinguisher unit and a surrounding area;
providing one or more images of the fire extinguisher unit and the surrounding area to an analysis module after each periodic monitoring;
determining, based on the one or more images, whether an internal pressure of the fire extinguisher unit is within a predetermined range of pressures and whether the surrounding area comprises any code violations; and
updating a user dashboard based on the determination.

2. The method of claim 1, further including:
monitoring, with a weight sensor, the fire extinguisher unit; and
periodically providing a weight of the fire extinguisher unit to the analysis unit for enabling further determining of whether the fire extinguisher has been one of partially and fully discharged.

3. The method of claim 2, further including:
determining, based on the weight of the fire extinguisher unit, whether the fire extinguisher unit is within a range of a predetermined weight range, wherein the predetermined weight range is associated with a fire extinguisher unit including a code required amount of fire retardant.

4. The method of claim 1, further including:
monitoring, with an accelerometer, for movement of the fire extinguisher unit; and
providing indication of movement to the analysis module when movement is detected.

5. The method of claim 4, further including:
monitoring the surrounding area with one or more cameras;
providing one or more images of the surrounding area to the analysis module;
determining, based on images of the surrounding area, whether one of an emergency and a code violation exists; and
updating the user dashboard as to whether one of an emergency and a code violation exists.

6. The method of claim 1, further including sending a user an alert based on the determination.

7. The method of claim 6, wherein the alert is sent using one or more of an SMS message, an email, and an automated phone call.

8. The method of claim 1, wherein the camera is arranged to image a pressure gauge of the fire extinguisher unit.

9. The method of claim 1, wherein a second camera arranged to image the surrounding area, the surrounding area including at least a six-foot radius arc or circle surrounding the fire extinguisher unit.

10. The method of claim 1, wherein the analysis module is connected to the one or more cameras and the user dashboard through one or more of wi-fi, a local area network, a wide area network, a cellular network, and a satellite network.

11. The method of claim 1, further including:
analyzing the one or more images using a machine learning module trained for image segmentation.

12. The method of claim 1, wherein the user dashboard is accessed by the user through a web-based portal.

13. The method of claim 1, wherein the fire extinguisher unit is enclosed in a cabinet.

14. The method of claim 13, wherein a first camera is mounted to a glass front surface of the cabinet and positioned to image a pressure gauge of the fire extinguisher unit.

15. The method of claim 13, wherein a second camera is mounted outside of the cabinet to image the surrounding area.

16. The method of claim 13, wherein a weight sensor is arranged in the cabinet to monitor a weight of the fire extinguisher unit.

17. The method of claim 13, wherein a transceiver unit is included in the cabinet to receive and provide information between the cabinet and the analysis unit, wherein the cabinet is connected to first and second cameras, a weight sensor and an accelerometer through a wire or wirelessly.
